(19) United States
(12) Patent Application Publication
(10) Pub. No.: US 2011/0274438 A1
(43) Pub. Date: Nov. 10, 2011

(54) OPTICAL ENGINE FOR POINT-TO-POINT COMMUNICATIONS

(76) Inventors: Marco Fiorentino, Mountain View, CA (US); Qianfan Xu, Mountain View, CA (US); Raymond G. Beausoleil, Redmond, WA (US); Sagi Varghese Mathai, Palo Alto, CA (US)

(21) Appl. No.: 13/143,902

(22) PCT Filed: Jan. 9, 2009
(86) PCT No.: PCT/US2009/030664

§ 371 Date: Jul. 8, 2011

(51) Int. Cl. H04B 10/12

(52) U.S. Cl. 398/141; 398/183; 398/187

(57) ABSTRACT

An optical engine (11) for providing a point-to-point optical communications link between devices. The optical engine (11) includes a light source (24) optically coupled to a modulation chip (6) and configured to generate an optical beam. The optical engine further comprises a modulator (21) carried on the modulation chip and configured to modulate the optical beam. The optical engine further includes a waveguide (30), formed in a plane parallel to the plane of the substrate, and configured to guide the modulated optical beam from the modulator to at least one of a plurality of out-of-plane couplers (40) grouped in a defined region (48) of the modulation chip. The out-of-plane coupler can couple the modulated optical beam to an optical device.

### BACKGROUND OF THE INVENTION

Computer performance is increasingly restricted by the ability of computer processors to quickly and efficiently access off-chip memory or communicate with other peripheral devices. The restriction is due, in part, to inherent physical limitations in the number of electrical pins that can fit into a connector of a defined size and surface area, which in turn determines the maximum electrical bandwidth. Saturation in the density of electrical pins results in “pin-out bottleneck” for a processor or chip, which describes the situation when the electrical bandwidth of a chip package becomes a performance limiting factor.

### BRIEF DESCRIPTION OF THE DRAWINGS

FIG. 1 is an illustration of a transmitting base unit having an optical modulator, according to an exemplary embodiment of the present invention;

FIG. 2 is an illustration of a transmitting base unit having a plurality of ring modulators, according to an exemplary embodiment of the present invention;

FIG. 3 is an illustration of a transmitting base unit having a ring modulator, according to an exemplary embodiment of the present invention;

FIG. 4 is an illustration of a receiving base unit, according to an exemplary embodiment of the present invention;

FIG. 5 is an illustration of an optical engine, according to an exemplary embodiment of the present invention;

FIG. 6 is an illustration of an optical engine, according to another exemplary embodiment of the present invention;

FIG. 7 is an illustration of an optical engine and a multi-core optical fiber, according to an exemplary embodiment of the present invention;

FIG. 8a is an illustration of a point-to-point optical communications link between optical engines formed on a first chip and a second chip, according to an exemplary embodiment of the present invention;

FIG. 8b is an illustration of a point-to-point optical communications link between optical engine chips bonded to first and second computing devices, according to an exemplary embodiment of the present invention;

FIG. 9 is an illustration of an optical engine, according to another exemplary embodiment of the present invention;

FIG. 10 is an illustration of a point-to-point optical communications link between optical engine chips bonded to a first and a second computing device, according to another exemplary embodiment of the present invention;

FIG. 11 is a flowchart describing a method for transmitting point-to-point communications between a first computing device and a second computing device, according to an exemplary embodiment of the present invention;

FIG. 12 is an illustration of a Fabry-Perot modulator for use in an optical engine providing point-to-point optical communications, according to an exemplary embodiment of the present invention; and

FIG. 13 is an illustration of multiple Fabry-Perot modulators as in FIG. 12 for modulating a multi-frequency optical beam, according to an exemplary embodiment of the present invention.

### DETAILED DESCRIPTION OF EXEMPLARY EMBODIMENTS

The following detailed description of exemplary embodiments of the invention makes reference to the accompanying drawings, which form a part thereof and in which are shown exemplary embodiments in which the invention may be practiced. While these exemplary embodiments are described, by way of illustration, in sufficient detail to enable those skilled in the art to practice the invention, it should be understood that other embodiments may be realized and that various changes to the invention may be made without departing from the spirit and scope of the present invention. As such, the following more detailed description of the embodiments of the present invention is not intended to limit the scope of the invention as it is claimed, but is presented for purposes of illustration only; to describe the features and characteristics of the present invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

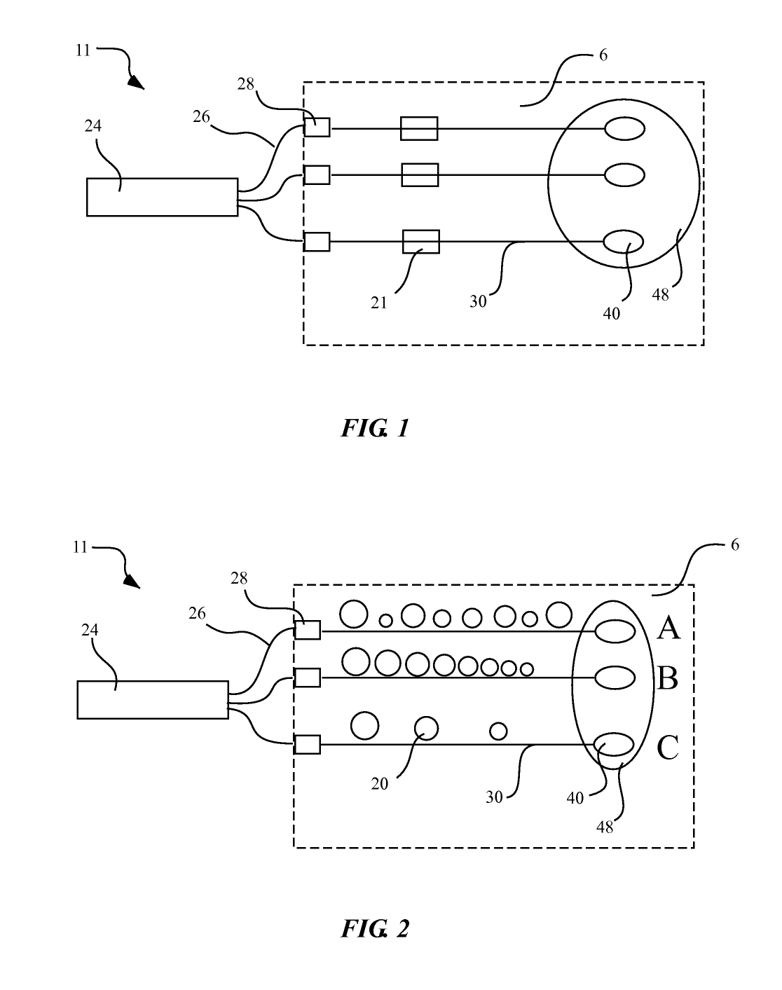

Illustrated in FIGS. 1-12 are various exemplary embodiments of the present invention for an optical engine for a point-to-point communication link between two computing devices, such as two computer chips. The optical engine can be used to overcome the increasing bottlenecks in computer performance resulting from the inability to quickly access off-chip memory or communicate with other peripheral devices. The restriction is due, in part, to inherent physical limitations in the number of electrical pins that can fit into a connector of a defined size and surface area, which in turn is a factor in determining the maximum bandwidth for communication. Thus, one exemplary application for the present invention can be to establish intra-chip or point-to-point optical communications between a microprocessor and a separate memory chip or device.

The optical engine is a combination of components which provides greatly improved performance at a reduced manufacturing cost. As will be described in more detail hereinafter, the optical engine can include a light source optically coupled to a modulation chip. The light source can be in a separate location from the modulation chip and can be optically coupled to the modulation chip by various means as are known in the art. The light source can generate an optical beam. At least one modulator may be carried on the modulation or optical engine chip and can modulate the optical beam generated by the light source. The modulator may be of any suitable type, including, but not limited to ring modulators and Mach-Zehnder modulators. For instance, the type of modulator may include one or more evanescent micro-ring modulators which are formed in a plane parallel to a plane of the optical engine chip or substrate. The modulator can modulate the optical beam to create an optical signal.

In addition, a waveguide can be carried on the modulation chip may be for guiding the modulated optical beam from the modulator to a defined location or region of the modulation chip (e.g. in the center of the chip or at the chip-edge). The defined region can have one or more out of plane couplers, such as grating couplers or the like, for optically coupling the modulated optical beam to an optical or electrical device. The modulated optical beam may be optically coupled from the out of plane coupler to the optical or electrical device through multi-core optical fibers for transport to the optical device. A plurality of out of plane couplers can be grouped in a relatively small, defined area. The out of plane couplers have a smaller size than an optical signal generator such as an LED or laser. This allows them to be grouped in a small area. A plurality of modulated optical signals can be coupled to a single optical waveguide, such as a multi-core fiber, fiber ribbon, or hollow metal waveguide using the plurality of out of plane couplers.

Photonic detectors can also be included in the defined area to receive optical signals broadcast from the optical or computing device. As a photonic optical signal detector, or photo-detector, is generally less complex than an optical signal generator (i.e. laser, LED, etc.) the photo-detectors can be located at the defined region to directly receive the input signals traveling through the multi-core optical fiber, or they can be distributed over the surface of the chip and similarly coupled to the multi-core optical fiber with grating coupling pads or tapered waveguides.

The optical engine of the present invention can help resolve the “pinout bottleneck” facing computer designers today, resulting from the approximate upper limit of a few thousand electrical pins per chip. Some of these electrical pins are used for CPU-to-memory traffic or other secondary communications which may lend themselves to point-to-point links. By providing direct optical connections between two computing devices and off-loading the CPU-to-memory or secondary communications into separate multi-channel, point-to-point optical links, a significant number of input/output pins can be reassigned to other uses, resulting in a substantial increase in bandwidth available for other internal computer operations.

The present invention provides further advantages over the prior art, which can include both traditional wired connectors and more recent developments in optical fiber communications technology. One benefit is lower manufacturing costs, since each component of the optical engine, including photo-detectors, waveguides, and optical couplers, can be manufactured using cost-effective, high-volume fabrication processes, such as VLSI (Very Large Scale Integration) fabrication techniques.

One distinct advantage of the present invention over the prior art is the capability to generate an optical beam at a location separate from the modulation chip. This allows for the use of a wide variety of types of lasers to be used. Oftentimes, lasers and other optical sources have a fairly limited operating temperature range. In some environments, it is necessary to locate the modulation chip near a heat generating computing component, such as a processor. This creates a less than optimal performance in the laser. Modulators are often operable in a wider temperature range than lasers. Thus, while the processor temperature may be within the acceptable range for modulator operation, it may be advantageous to move the laser to a location with a more suitable temperature. The laser or other optical source can create an optical beam that is carried to the modulation chip through a fiber optic cable, large core hollow metal waveguide, free space, or other optical transport device. The optical beam can be coupled to the modulation chip using any of a variety of different components as are known in the art. Some such components may include grating couplers, taper couplers or edge couplers.

It is an advantage of the present invention that a light source, such as a laser, may be located in a separate location from a modulation chip and that modulators and/or photo-detectors can be distributed over the surface of the optical engine chip, along with waveguides for guiding the optical signals to and from a defined region, so that a large number of optical signals can be concentrated and organized into a small footprint configurable for coupling into a single multi-core optical fiber, such as a photonic crystal fiber or an optical fiber ribbon. With prior optical systems, therefore, a separate chip with detectors may be required to receive an incoming signal and complete the duplex communications link. In contrast, each component of the present invention can be fabricated using silicon based or III-V group semiconductor materials, allowing for the micro-ring modulators, the receiving photo-detectors and their associated components to be integrated into the same chip. In alternate embodiments, the modulators and photodetectors may be fabricated from silicon, germanium, silicon germanium or combinations of these materials.

The present invention offers additional benefits that can be attractive to computer designers and engineers. For instance, all the point-to-point traffic between the two computing devices can be handled by a single multi-core optical fiber, such as a photonic crystal fiber or optical fiber ribbon, which can be actively or passively aligned to the optical couplers, and which can be attached to the defined region on the optical engine using proven adhesive materials and methods. Moreover, the present invention provides the convenience and flexibility of directly integrating the optical engine into the computing device, or fabricating the engine on a separate chip for subsequent wafer-mounting to the computing device.

Each of the above-recited advantages and improvements will be apparent in light of the detailed description set forth below, with reference to the accompanying drawings. These advantages are not meant to be limiting in any way. Indeed, one skilled in the art will appreciate that other benefits and advantages may be realized, other than those specifically recited herein, upon practicing the present invention.

Illustrated in FIG. 1 is a transmitting base unit 11, according to an exemplary embodiment of the present invention, which can be used to generate an optical signal modulated by a first computing device (not shown), and to couple the optical signal into a multi-core optical fiber for transport to a second computing device. The transmitting base unit can include a light source 24, such as a laser or light emitting diode, for generating an optical beam. The light source can be located in a separate location from a modulation chip 6 and can be optically coupled to the modulation chip. In one exemplary embodiment, the light source is optically coupled to the modulation chip by an optical fiber 26. An optical beam can be generated by the light source, travel through the optical fiber and can be coupled to the modulation chip by a variety of types of optical couplers 28, such as, but not limited to, grating couplers, taper couplers, or edge couplers. The optical coupler 28 can be any variety of standard, evanescent, or pigtail coupling.

After being coupled to the modulation chip 6, the optical beam may be modulated by a modulator 21. The modulator may be carried on the modulation chip and configured to modulate the optical beam generated by the light source 24. The modulator may be any of a variety of types of modulators, as are known in the art. Some contemplated examples of modulators include micro-ring modulators, Mach-Zehnder modulators, Alexander modulators, or absorption modulators. While the figures and much of the discussion herein is directed towards use of micro-ring modulators, it is to be understood that any suitable type of modulator for modulating an optical beam may be used to modulate the optical beam of the present invention.

Also carried on the modulation chip 6 is a waveguide 30, configured to guide the modulated optical beam from the modulator 21 to at least one of a plurality of out-of-plane couplers 40 grouped in a defined region of the modulation chip. The waveguide structure may be formed in a number of configurations as are known to one having skill in the art. In one embodiment, the waveguide may be a Silicon-on-Insulator waveguide. Alternatively, a polymer waveguide may be used.

In one aspect, the optical beam may travel along the waveguide before reaching the modulator and then continue along the waveguide as a modulated optical beam, or optical signal. In another aspect, the optical beam may travel along a first waveguide to the modulator, and then travel along a second waveguide from the modulator to the defined region. In another aspect, the optical beam may be modulated by the modulator upon being coupled to the modulation chip, such that the optical beam does not pass through a waveguide until after modulation.

At an end of the waveguide 30 is a defined region 48 wherein is grouped a plurality of out-of plane couplers 40. In one aspect, the out-of-plane couplers may be grating couplers. The modulated optical beam, or optical signal, can travel parallel to a plane of the modulation chip 6 within the waveguide 30 to the out-of-plane coupler. The out-of-plane coupler then redirects the optical beam to travel out-of-plane to the modulation chip. It is contemplated that a plurality of optical beams may be modulated by a plurality of modulators and travel to the defined region to respective out-of-plane couplers all grouped and configured to be located within the region. In one embodiment, an end of a multi-core optical fiber may cover the region when coupled to the modulation chip.

In embodiments where the modulation chip 6 comprises multiple waveguides 30, a single light source 24 may generate an optical beam which is then split and carried to each of the waveguides. The beam may be split at a splitter on the modulation chip, or may be split before (as is shown in FIG. 1). Alternatively, a plurality of light sources may be used to each generate an optical beam to be carried to one or more waveguides. It is also contemplated that a single light source may generate an optical beam to be used on a plurality of modulation chips. Alternatively, a plurality of light sources may each generate an optical beam for at least one modulation chip.

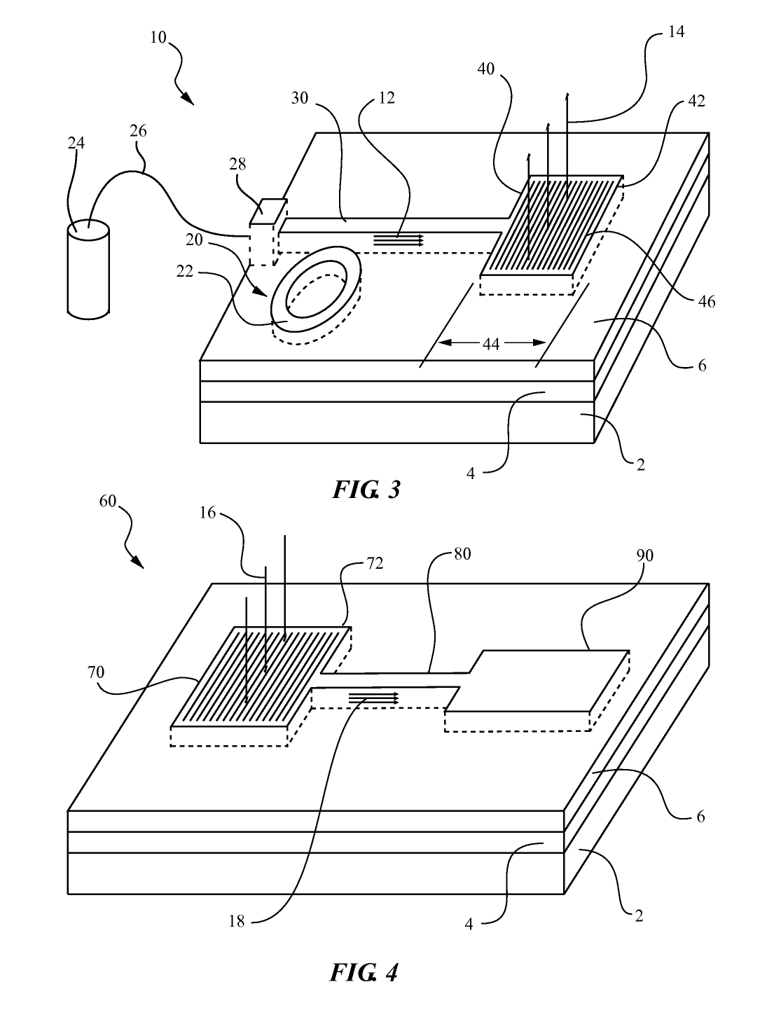

FIG. 2 illustrates a device 11 similar in many regards to the device of FIG. 1. Whereas, FIG. 1 depicts a single modulator 21, associated with each waveguide 30, the device of FIG. 2 illustrates an embodiment wherein a plurality of modulators, in this case ring modulators 20, are associated with each waveguide 30. The ring modulators can be located sufficiently close to the waveguide to enable evanescent coupling of the optical signal into the ring modulator. It is noted that the ring modulators shown are each different sizes. Ring modulators are operable to modulate a particular wavelength of an optical beam. The wavelength modulated by the ring modulator correlates to the size of the ring modulator. Ring modulators are designed to be resonant at a particular wavelength. The optical beam generated by the optical source 24 may comprise a plurality of wavelengths correlating to a plurality of frequencies which may be modulated by the ring modulators. Each ring modulator can effectively couple its resonant frequency from the waveguide. The resonance of the ring modulator can be controlled electronically, thereby enabling the coupling of the light to be turned on and off at a desired rate. Ring modulators can be used to modulate a selected wavelength at rates greater than 1 GHz, and in some instances at rates greater than 10 GHz, thereby enabling data to be transmitted at gigabit rates.

Any number of modulators may be used in series, and it is not necessary that the frequencies be modulated in a particular order. As shown in FIG. 2, a modulation chip may have any variety of modulators. For example, at A is a series of ring modulators for modulating frequencies in random order. At B is a series of ring modulators positioned in order of largest to smallest, going left to right. At C is a series of ring modulators in an order similar to those shown at B, but the series at C has fewer modulators in series. As can be understood, the order, number, and type of modulator, can be varied and selectively determined to suit the needs of a particular application.

Illustrated in FIG. 3 is a transmitting base unit 10, according to an exemplary embodiment of the present invention, which can be used to generate an optical signal, and to couple the optical signal into a multi-core optical fiber for transport to a second computing device. An optical source 24 can be used to generate an optical signal that is coupled to the transmitting base unit through, for example, an optical fiber 26. A taper coupler 28 can be used to couple the optical signal to an waveguide 30. A ring modulator can be used to modulate a selected wavelength of the optical signal to form a modulated optical signal 12. Each of the components in the transmitting base unit can be fabricated using known high-volume (for example, VLSI) fabrication techniques on one or more underlying base layer(s) 4 formed on top of a silicon-based chip substrate 2. Although the transmitting base unit components are represented in FIG. 3 as being formed in a single optical engine layer of the modulation chip 6 overlying the base layer(s) 4 and substrate 2, it can be appreciated by one with skill in the art that the various base unit components, particularly the micro-ring modulator 20, can be built up of various sub-layers formed from differing materials. For example, the micro-ring modulator can be fabricated from seven or more differing layers used to create the under-cladding, the micro-ring resonator and waveguide, etc.

It can be further appreciated that, other than the optical source, the components of the transmitting base unit can be embedded within the optical engine layer 6 as illustrated, or can be formed to extend above the top of the layer and be surrounded by empty space or a transparent protective coating. Electrical connections between the optical engine and a driving computing device can be provided for in the underlying base layer(s) 4.

Another aspect of the present invention's flexibility is the micro-ring laser's configurability for both single and multi-mode operation. In an exemplary embodiment, for instance, the optical engine of the present invention can be configured for single-mode operation centered around the 1310 nm or 1550 nm wavelengths.

The operation and functionality of the micro-ring laser 20, including its configurability for both single and multi-mode operation, are more specifically set forth in commonly owned and co-pending PCT Patent Application No. PCT/US081/62791, filed May 6, 2008, and entitled “System and Method For Micro-ring Laser,” which is incorporated by reference in its entirety herein.

In the embodiment illustrated in FIG. 3, the micro-ring modulator 20 can be used to modulate a wavelength of the optical beam 12 carried by the optical waveguide 30. The waveguide 30 carries the modulated optical signal 12 to an out-of-plane or transmitting optical waveguide coupler 40. As multiple transmitting base units 10 can be formed on a single chip, the distance between the micro-ring laser and the waveguide coupler is relatively short, on the order of 100 μm or less, which serves to minimize the loss or attenuation of the optical signal as it travels through the solid silicon waveguide. In an exemplary embodiment, the waveguide 30 can have a square or rectangular cross section with dimensions of about 0.5 μm×0.5 μm.

The out-of-plane transmitting optical coupler 40 is used to redirect the output optical signal out-of-plane relative to the plane of the underlying substrate 2. Differing types of optical coupling devices, such as silvered mirrors, beamsplitters, optical grating pads, etc., can be used to redirect the optical beam out-of-plane. In an exemplary embodiment, the optical signal can be redirected to be substantially perpendicular, or 90 degrees, to the plane of the substrate, but it is to be appreciated that re-directing the optical beam at angles of about 30 degrees or more for coupling into a multi-core optical fiber can also be considered to fall within the scope of the present invention.

One low-cost but highly effective device for coupling the output optical signal 12 out-of-plane to the plane of the substrate can be a grating pad coupler 42. The grating pad coupler can generally comprise an expanded section or pad 44 of the optical waveguide 30 that can be made from the same or differing material and which can be formed integrally with or separate from the waveguide. The pad 44 can have a width much greater than its thickness. A grating pattern of slots 46 can be etched or otherwise formed in the top surface of the grating pad coupler and extend downward into the body of the grating pad coupler. The grating coupler can operate on the principle of light diffraction, wherein an optical signal contacting a single slot as it travels through the pad material will be split into several components, including a transmitted component, a reflected component, and an out-of-plane component. By using multiple slots which are precisely dimensioned and spaced along the top surface of the grating pad, a substantial portion of the optical beam can be re-directed into a transmitted optical signal 14 traveling out-of-plane to the plane of the waveguide.

The efficiency of the grating coupler in redirecting the optical signal 12 out-of-plane relative to the plane of the substrate 2 can be optimized through control of the dimensions and spacing of the grating slots relative to the wavelength of the optical beam. Thus, the grating coupler can be tuned or optimized for the center wavelength of laser light emitted by the micro-ring laser, as can the waveguide which connects the two devices together. Tuning the entire transmitting base unit to the wavelength of light generated by the micro-ring laser, such as to the 1310 nm or 1550 nm wavelengths described above, can simultaneously maximize the output of the base unit while minimizing the loss of the optical signal moving through each component, resulting in an optical engine with reduced power requirements.

Illustrated in FIG. 4 is a receiving base unit 60, according to an exemplary embodiment of the present invention. The receiving base unit is organized similar to the transmitting base unit, with a receiving out-of-plane optical coupler 70 and waveguide 80 leading to an optical device. In the case of the receiving unit, the received optical signal 18 travels in the opposite direction (i.e. from the out-of-plane optical coupler to the optical device). The optical device can be a photonic optical signal detector such as a photo-detector 90.

The receiving optical coupler 70 can be used to redirect an incoming optical beam or input optical signal 16 traveling out-of-plane relative to the plane of the substrate 2 into a received optical signal 18 moving through the waveguide 80 and parallel to the plane of the substrate 2. The receiving optical coupler 70 can be substantially identical to the transmitting optical coupler, and can further include various types of optical coupling devices, including a silvered mirrors, beam splitters, optical grating pads, etc.

In the exemplary embodiment illustrated in FIG. 4 the receiving optical coupler 70 can be a grating pad coupler 72 that is substantially identical to the grating pad coupler used in the transmitting base unit. The reasons for this can be two-fold. One reason is that grating couplers can be equally efficient at redirecting light traveling in both directions. The other reason is, as will be described in more detail hereinafter, identical optical engines optimized to a specific wavelength of light can often be used in pairs, with the receiving portion of one engine tuned to receive and transport the optical beam generated by the transmitting portion of the other. Consequently, the grating pad coupler 72 located on a receiving base unit 60 can be configured to receive an input optical signal 16 originally generated and transmitted from a transmitting base unit optimized to the same wavelength of light, in which case both grating couplers can be substantially identical.

Once the input optical signal 16 has been captured and coupled into the receiving base unit by the grating coupler 72, the received optical signal 18 can be transported along the waveguide 80 to the photo-detector 90. The photo-detector can include differing types of optical detecting devices, such as a layer of germanium, silicon germanium, or III-V material, a p-i-n or Schottky diode, a photo-transistor, etc. In an exemplary embodiment, however, the photo-detector can be made from the same III-V group semiconductor materials as the micro-ring modulator, or a micro-ring laser, to facilitate the fabrication of the optical engine.

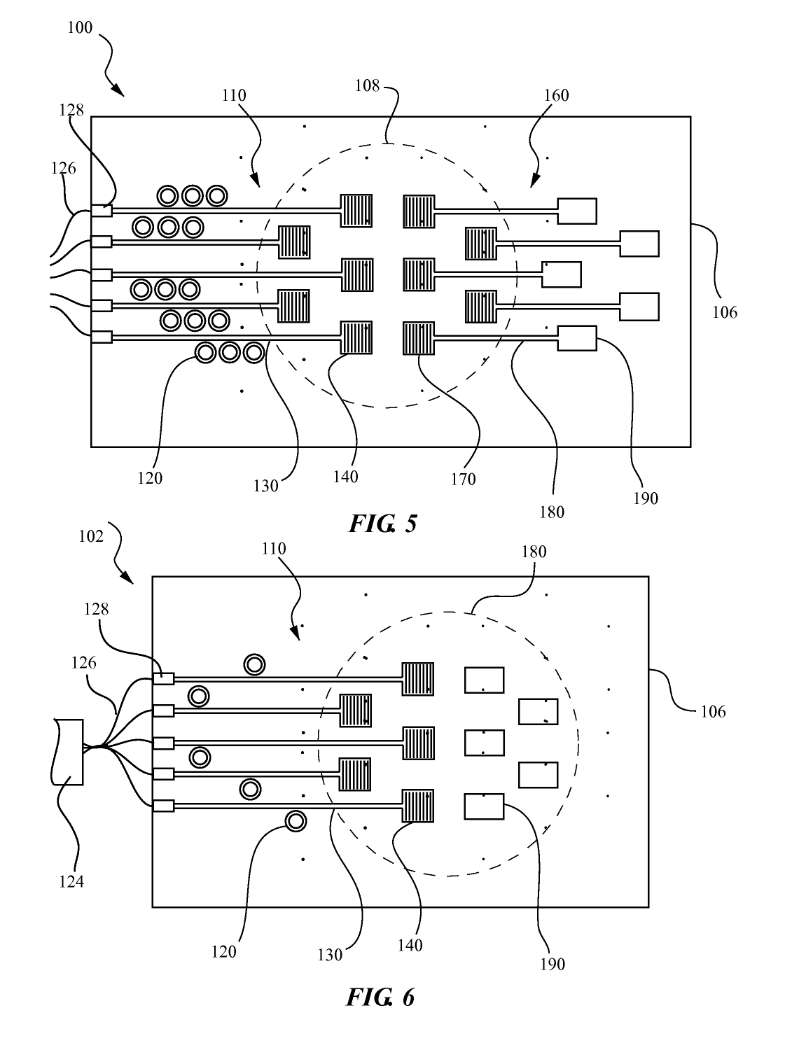

Reference will now be made to FIGS. 5 and 6. Illustrated are exemplary embodiments 100 of the optical engine, which combines a plurality of both transmitting 110 and receiving 160 base units on a single chip 106 to allow for full duplex operation between optical devices. A plurality of five transmitting base units 110, each further comprising a separate modulator 120, a waveguide 130 and a transmitting grating coupler 140, can be organized on the chip so that the modulators are distributed toward the periphery and the grating couplers are concentrated within a central location or defined region 108. Each of the transmitting base units may further comprise a separate optical source, or a common optical source 124 and separate optical fibers 126 which are coupled to the optical engine by couplers 128, as has been described above. A plurality of five receiving base units 160 can each further comprise a receiving grating coupler 170, a waveguide 180 and a photo-detector 190, and can be similarly organized on the chip so that the photo-detectors are distributed toward the periphery and the receiving grating couplers 170 are congregated within the same centralized defined region 108, adjacent the transmitting grating couplers 140.

FIG. 5 illustrates the advantages provided by transmitting 110 and receiving 160 base units that operate in a plane parallel to the plane of the chip or substrate 106. This “horizontal” orientation removes the prior art limitation of placing the lasers themselves at the defined region 108, and allows for a large number of modulators 120 and photo-detectors 190 to be distributed over the surface of the optical engine substrate 106, while using relatively narrow waveguides 130, 180 to efficiently route or direct the optical signals to the grating couplers 140, 170 concentrated at the defined location. FIG. 5 illustrates an exemplary embodiment having ten grating couplers formed at the defined location, but it is to be appreciated that the small footprint of the grating couplers 140, 170 and the narrow width of the silicon waveguides 130, 180 can allow the defined region to be configured for at least thirty or more optical channels. In addition, the use of an off-chip optical light source enables a plurality of different types of optical signals to be created and coupled to the plurality of optical channels of the optical engine. For example, one or more optical light sources may be used, including a light emitting diode, a single-mode laser, a multi-mode laser, a mode-locked laser operable to produce a multiple wavelength frequency comb output for dense wavelength division multiplexing, and so forth. Channels carrying a single mode optical signal may have a single modulator, while channels carrying a frequency comb signal may include multiple modulators, even tens of modulators, such as the ring modulators 120 shown. As previously discussed, use of an off-chip optical light source also enables the optical engine to be used in relatively high heat locations, such as being mounted on a chip. Optical light sources, such as lasers, typically do not function well in high heat locations.

Shown in FIG. 6 is an alternative embodiment 102 of the optical engine, in which the photo-detectors themselves can be located at the defined region to directly receive one or more optical signals transmitted from a second off-chip source. The second off-chip source may be a memory chip, a processing chip, a modulation chip, a second signal source, and the like. The transmitted signal can be coupled to the optical engine through an optical waveguide, such as the multi-core optical fiber, to enable the transmitted signal(s) to be communicated to the defined region 108. The transmitted signal can then be received directly at the photo-detectors 190. Photo-detectors are generally less complex than optical signal generators (i.e. laser, LED, etc.), and can be configured to receive an optical signal either parallel to or out-of-plane to the plane of the substrate 106. The receiving base units in the previous embodiments can be replaced with just the photo-detectors 190 themselves, which can be located inside the defined region 108 in generally the same positions as the receiving grating couplers. This embodiment can simplify fabrication of the optical engine chip and reduce costs, and can allow for more of the surface area of the chip to be devoted to the placement of transmitting base units.

The positioning of the transmitting grating couplers 140 and the photo-detectors 190 within the central location or defined region 108 as shown in FIG. 6 is only representative, and is not limited to the side-by-side configuration shown. It is to be appreciated by one having skill in the art that the transmitting base units 110 and photo-detectors 190 can be repositioned and intermixed inside the defined region 108 and over the surface of the optical engine chip 106 in a variety configurations to optimize component distribution, lines-of-sight to the multi-core optical fiber, and electrical pathways formed in the underlying base layer(s).

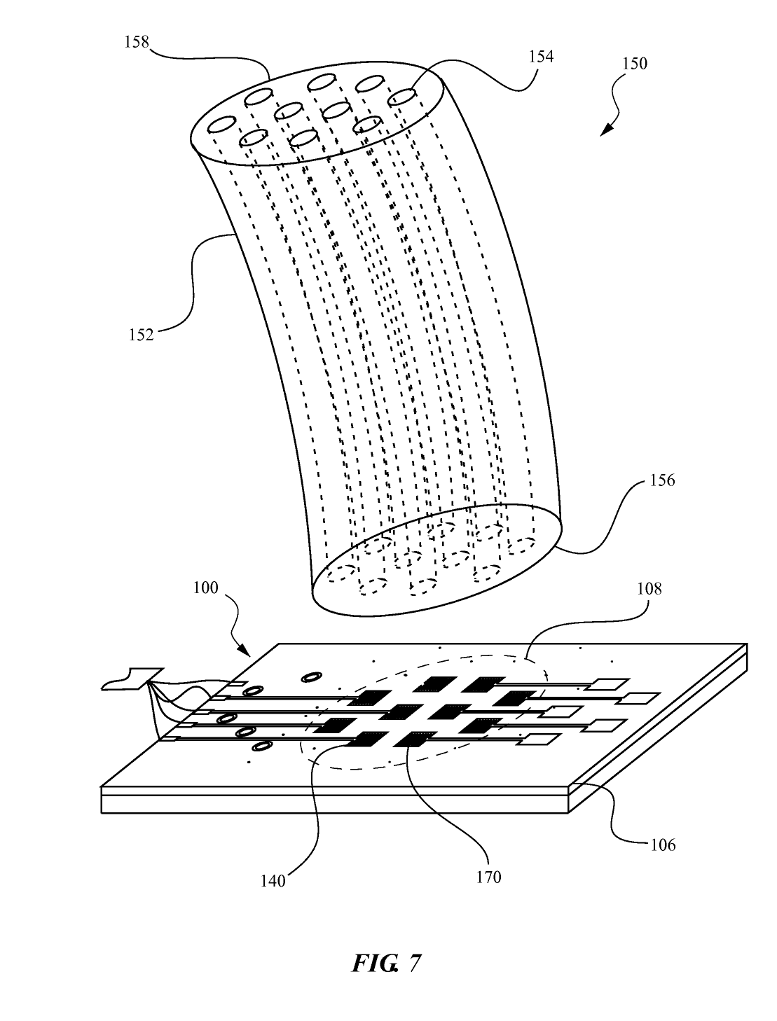

FIG. 7 is an illustration of an optical engine 100 coupled to an off-chip waveguide such as a single- or multi-mode, multi-core optical fiber 150. The off-chip waveguide is an optical waveguide configured to communicate optical signals to and from the defined region 108. For example, the off-chip waveguide may be a photonic crystal fiber, according to an exemplary embodiment of the present invention. The multi-core optical fiber can comprise an outer layer or sheath 152 surrounding a plurality of optical cores 154 miming through the length of the multi-core optical fiber. The cores can comprise a substantially transparent material formed from a solid, a gas, a liquid or a void, which allows the optical signal to propagate through the core. Moreover, the cores 154 can have a uniform cross-section and spacing apart from each other along the length of the fiber 150. It is to be further understood that the configuration of the optical cores of the multi-core optical fiber can be compatible with the type of optical signals produced by off-chip laser, and can thus be configurable for single- or multi-mode operation.

The multi-core optical fiber 150 can have a proximate end 156 for coupling to the central location or defined region 108 of the optical engine chip 106, and a distal end 158 for coupling to one or more passive optical devices, active optical devices, additional optical engines, and the like. The proximate end 156 can be coupled to the defined region 108 of the optical engine chip 106 so that the optical cores 154 align with the out-of-plane optical couplers 140, 170 located within the defined region. The proximate end 156 of the fiber 150 can also be attached to the top surface of the optical engine chip 106 with an appropriate adhesive, attachment method or attachment structure.

Alignment of the optical cores 154 with the out-of-plane optical couplers 140, 170 can be accomplished through passive, or self-alignment methods, as well as active methods that monitor the strength of one or more optical signals passing through the multi-core optical fiber 150, such as a photonic crystal fiber, as the fiber is coupled to the chip. More detail on the various aspects and methods for aligning and coupling the multi-core optical fiber to the optical engine is specifically set forth in commonly owned and co-pending U.S. patent application Ser. No. 12/254,490, filed Oct. 20, 2008, and entitled “Method for Connecting Multicore Fibers to Optical Devices,” which is incorporated by reference in its entirety herein.

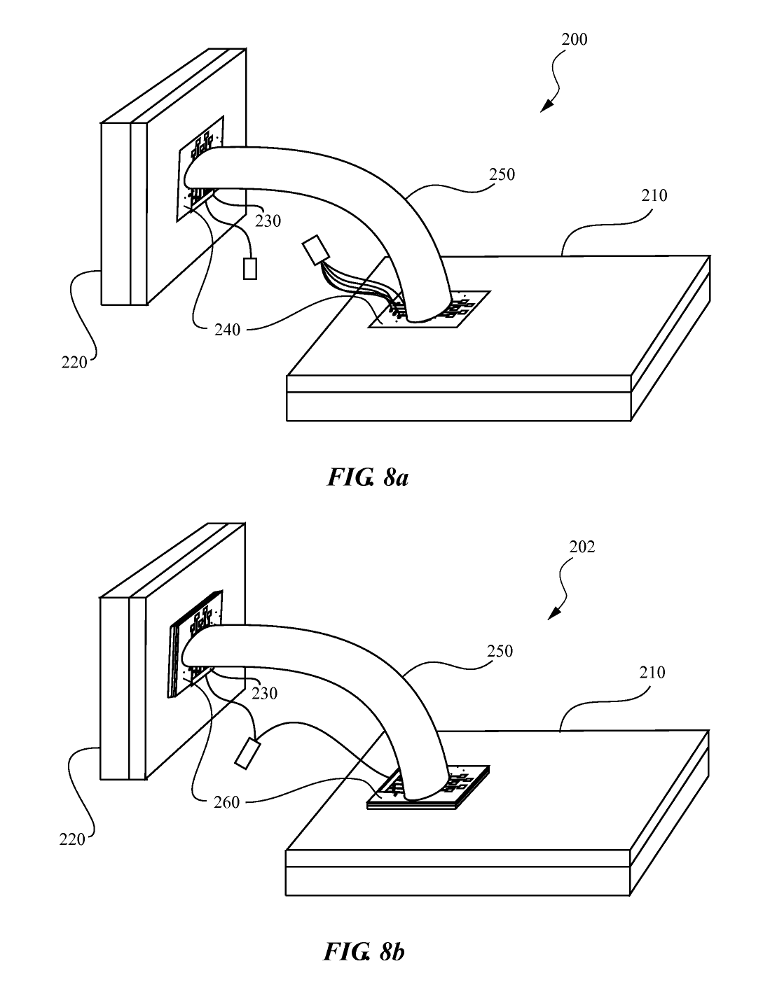

Illustrated in FIG. 8a is a point-to-point optical communications link 200 between optical engines directly integrated into a first and second computing device, such as a central processing unit 210 and a separate memory chip 220. In this exemplary embodiment, the optical engines 240 can be integrated directly into the circuitry of the computing devices 210, 220 during fabrication, and then connected with a multi-core optical fiber 250 that is coupled and aligned to the defined regions of both optical engines. It is noted that the optical source can either provide an optical beam to multiple optical fibers each for transporting the optical beam to a separate waveguide, or alternatively, a single optical fiber may carry an optical beam to the optical engine where a splitter 230 splits the beam to each of the separate transmitting waveguides on the optical engine.

FIG. 8b further illustrates another aspect of the present invention, in which separate optical engine chips 260 have been wafer mounted to the two adjacent computing devices 210, 220, and then linked with the multi-core optical fiber 250 to create the point-to-point optical communications link 202. Forming the optical engines on separate chips 260 which are later attached to the computing devices can provide for greater control over the manufacturing processes used in fabricating the chip and for economies of scale in reducing fabrication costs. Separate optical engine chips 260 can also allow for the creation of a communications protocol that is substantially independent of the computing device upon which the optical engine is mounted. It is also noted here that in some embodiments, a single optical source or laser may be optically coupled to a plurality of optical engine chips. The optical source beam may be split at a splitter 230 on the optical engine chips as is shown. Alternatively, as has been previously discussed, a separate optical fiber may transport an optical beam to each transmitting waveguide on each of the optical engine chips.

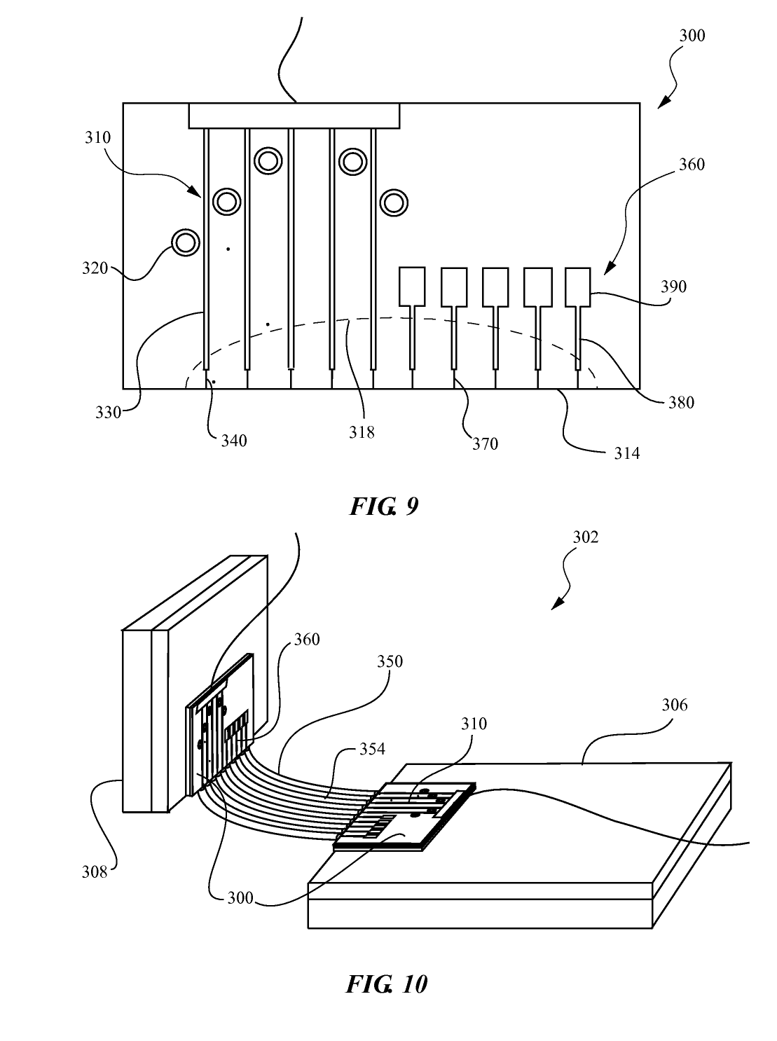

FIGS. 9 and 10 together illustrate another exemplary embodiment of a point-to-point optical link 302 created between optical engine chips 300 that can be wafer mounted to first 306 and second 308 computing devices. In this embodiment, both the transmitting base units 310 and the receiving base units 360 formed in the optical engine chip 300 can be orientated towards an edge 314 of the chip, instead of towards the center of the chip as described in previous embodiments. In the transmitting base units 310, an output optical beam can be generated in an off-chip laser, transported to micro-ring modulators 320 for modulation, and transported in output waveguides 330 towards a defined region 318 organized around the edge 314 of the chip or substrate, for coupling into an optical fiber ribbon 350 that can be aligned with the waveguides 330 and orientated parallel to the plane of the substrate. Prior to reaching the edge, however, the optical signal can be passed into waveguide tapers 340 which transform the mode of the optical signal into the fundamental mode of the individual optical fibers 354 forming the optical fiber ribbon.

The optical fiber ribbon 350 can carry the output signal to the receiving portion of a similar optical engine chip 300 mounted on another computing device 308 (see FIG. 10). And in a reciprocal duplex fashion, the off-chip laser coupled to the second optical engine chip can be used to send an optical signal to the second optical engine, where a desired form of modulation can occur and a modulated signal can be sent back through the optical fiber ribbon 350 to the optical engine chip mounted on the first computing device 306 for reception through waveguide tapers 370 (see FIG. 7) into input waveguides 380 that can carry the input optical signal to a receiving photo-detector 390.

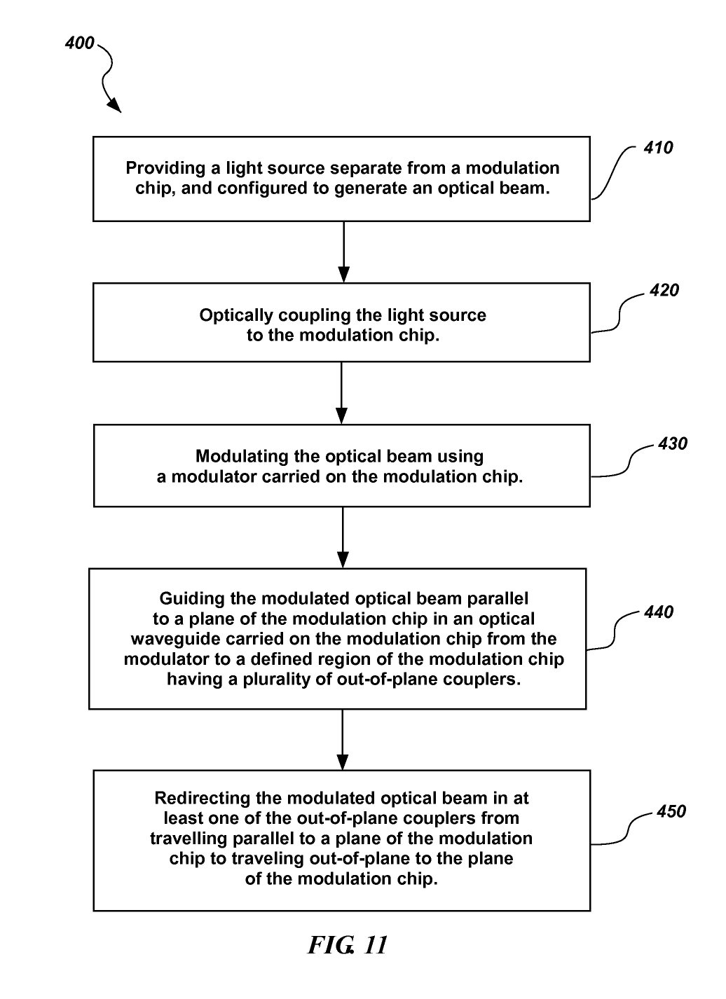

FIG. 11 is a flowchart describing a method 400 for transmitting point-to-point communications between a first computing device and a second computing device, according to an exemplary embodiment. The method includes the operations of providing 410 a light source configured to generate an optical beam, wherein the light source is located separate from a modulation chip and optically coupling 420 the light source to the modulation chip. The method further includes the operations of modulating 430 the optical beam using a modulator carried on the modulation chip, followed by guiding 440 the modulated optical beam parallel to a plane of the modulation chip in an optical waveguide carried on the modulation chip from the modulator to a defined region of the modulation chip having a plurality of out-of-plane couplers. The modulated optical beam can then be redirected 450 in at least one of the out-of-plane couplers from traveling parallel to the plane of the modulation chip to traveling out-of-plane to the plane of the modulation chip.

The method may further include one or more additional steps such as: detecting an optical signal at detectors located in the defined region; splitting the optical beam before modulation and recombining the optical beam after modulation; modulating a plurality of frequencies of the optical beam using a plurality of micro-ring laser modulators; or coupling the modulated optical beam into a multi-core optical fiber, wherein the multi-core optical fiber is configured to transmit the modulated optical beam to an optical or electronic device.

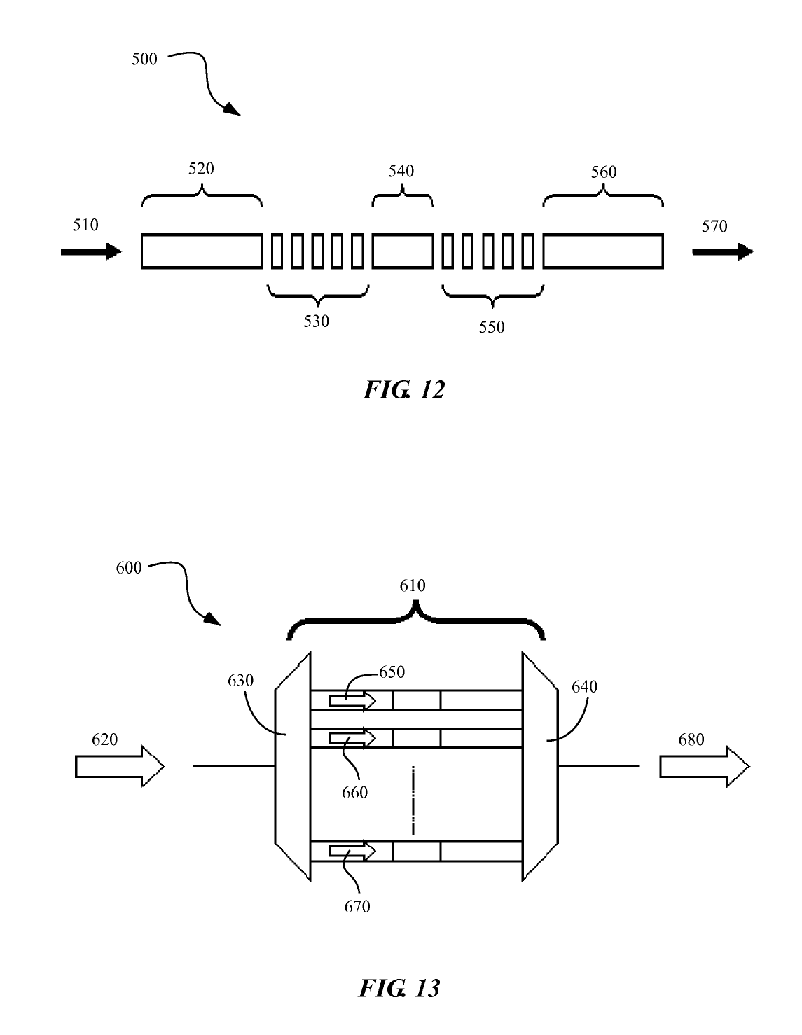

In some embodiments, photonic crystal resonators may be used to modulate an optical beam. Illustrated in FIG. 12 is a nano-cavity Fabry-Perot modulator 500. This modulator is made with at least one Distributed Bragg Reflector (DBR) 530 outside the active medium (the active region) 540. A DBR is a Bragg mirror, i.e., a light-reflecting device (a mirror), based on Bragg reflection at a periodic structure. The modulator contains a waveguide structure 520, 560 providing wavelength-dependent feedback to define the emission wavelength. The waveguide 520 may be passive and configured to receive an input optical beam 510. Another waveguide 560 may be on an opposite side of the active region 540 and serve to carry an output optical signal 570. A section of the optical waveguide acts as the modulating medium (active region) 540, and the other end of the resonator may have another DBR 550. In some embodiments, the DBR may be wavelength-tunable. Tuning within the free spectral range of the modulator may be accomplished with a separate phase section, which can be tuned by being electrically heated, or simply by varying the temperature of the active region via the drive current. If the temperature of the whole device is varied, the wavelength response is significantly smaller than for an ordinary single-mode laser diode, since the reflection band of the grating is shifted less than the gain maximum. Electro-optic tuning or tuning by the plasma dispersion effect can also be accomplished. Mode-hop free tuning over a larger wavelength region is possible by coordinated tuning of the Bragg grating and the gain structure.

FIG. 13 illustrates multiple Fabry-Perot modulators 600, such as those described above, used in parallel 610. The optical beam input 620 comprises multiple wavelengths. The multiple wavelength input can be a frequency comb signal, a dense wavelength-division multiplexing (DWDM) signal, or a broadband light source such as an LED. Depending on the light source, the free spectral range of the modulators may be designed to match the spacing between frequency combs, DWDM signals, or the channel spacing of the demultiplex (DEMUX 630) and multiplex (MUX 640). This allows the use of identical modulators in the modulator array. The MUX is optional and depends on the chip's architecture. At DEMUX 630, the multiple wavelength input 620 can be demultiplexed, or split, into two or more wavelengths 650, 660, and 670. The different wavelength optical beams 650, 660, 670 can then be modulated in a manner similar to that described for FIG. 12 above. At MUX 640, the different wavelength optical beams, or signals, may then be multiplexed, or combined, to form a single multi-wavelength output optical signal 680.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims.

What is claimed is:

1. An optical engine (11) for modulating optical communications comprising:
a light source (24) located separate from and optically coupled to a modulation chip (6) and configured to generate an optical beam;
a modulator (21) carried on the modulation chip and configured to modulate the optical beam generated by the light source;
a waveguide (30) carried on the modulation chip and configured to guide the modulated optical beam from the modulator to a defined region (48) of the modulation chip having a plurality of out-of-plane couplers (40); and
wherein at least one of the out-of-plane couplers is configured to optically couple the modulated optical beam to an optical device.

2. An optical engine in accordance with claim 1, wherein a plurality of optical beams are guided by a plurality of optical waveguides to the plurality of out-of-plane couplers, respectively.

3. An optical engine in accordance with claim 1, wherein a multi-core optical fiber (150) is used to couple the modulated optical beam to the optical device, and wherein a diameter of the multi-core optical fiber is at least as wide as the defined region.

4. An optical engine in accordance with claim 1, wherein the modulator is a micro-ring modulator (20).

5. An optical engine in accordance with claim 1, further comprising a photonic detector (70) located at the defined region and configured to receive optical signals from the optical device.

6. An optical engine in accordance with claim 1, further comprising a plurality of modulators located in series along the waveguide, wherein each modulator is configured to modulate the optical beam at a separate wavelength.

7. An optical engine in accordance with claim 1, further comprising a plurality of Fabry-Perot modulators located in parallel, and wherein the optical beam is split into separate wavelengths before modulation with the plurality of Fabry-Perot modulators.

8. An optical engine in accordance with claim 7, wherein the optical beam is recombined after modulation as a single modulated beam.

9. An optical engine in accordance with claim 1, wherein the out-of-plane coupler is a grating coupler.

10. An optical engine in accordance with claim 1, wherein the modulator is a Fabry-Perot array.

11. A method for modulating optical communications in the optical engine of claim 1, comprising:
optically coupling the light source to the modulation chip;
modulating the optical beam using the modulator (21) carried on the modulation chip;
guiding the modulated optical beam parallel to a plane of the modulation chip in the optical waveguide (30) carried on the modulation chip from the modulator to the defined region (48) of the modulation chip having the plurality of out-of-plane couplers (40); and
redirecting the modulated optical beam in at least one of the out-of-plane couplers from traveling parallel to the plane of the modulation chip to traveling out-of-plane to the plane of the modulation chip.

12. A method in accordance with claim 11, further comprising detecting an optical signal at detectors (70) located in the defined region.

13. A method in accordance with claim 11, further comprising splitting the optical beam before modulation and recombining the optical beam after modulation.

14. A method in accordance with claim 13, further comprising modulating a plurality of frequencies of the optical beam using a plurality of micro-ring laser modulators.

15. An optical engine (11) for modulating optical communications comprising:
a light source (24) configured to generate an optical beam having a plurality of frequencies, and wherein the light source is located separate from and optically coupled to a modulation chip (6);
a plurality of modulators (20) carried on the modulation chip and respectively configured to each modulate one of the plurality of frequencies of the optical beam generated by the light source;
a waveguide (30) carried on the modulation chip and configured to guide the modulated optical beam from the plurality of modulators to a defined region (48) of the modulation chip having a plurality of out-of-plane grating couplers (40), wherein at least one of the out-of-plane grating couplers is configured to optically couple the modulated optical beam through an off-chip optical waveguide to an optical device; and
a plurality of detectors within the defined region configured to receive a second modulated optical beam transmitted through the off-chip optical waveguide to the defined region on the optical engine (11).
